(19) United States
(12) Patent Application Publication
(10) Pub. No.: US 2018/0304316 A1
(43) Pub. Date: Oct. 25, 2018

(54) SYSTEMS AND METHODS TO CLEAN DUCTS

(71) Applicants: Sebastien Khandjian, Dubai (AE); John Khandjian, Dubai (AE)

(72) Inventors: Sebastien Khandjian, Dubai (AE); John Khandjian, Dubai (AE)

(21) Appl. No.: 15/588,275

(22) Filed: May 5, 2017

Related U.S. Application Data
(60) Provisional application No. 62/488,490, filed on Apr. 21, 2017.

(51) Int. Cl. B08B 3/10; B08B 9/027

(52) U.S. Cl. CPC B08B 3/10; F04D 19/002; B08B 9/027

(57) ABSTRACT

The disclosed embodiments include systems and methods to clean ducts. In one embodiment, the method includes detecting airflow into an exhaust duct. The method also includes dosing, in response to detecting airflow into the exhaust duct, an amount of a treatment product with a fluid to produce a treatment fluid. The method also includes pumping the treatment fluid into a pipe deposited along the exhaust duct. The method also includes spraying the treatment fluid through a nozzle coupled to a section of the pipe to clean buildup formed along an area of the exhaust duct proximate to the nozzle.

### BACKGROUND

The present disclosure relates generally to systems and methods to clean ducts, and more particularly, systems and methods to clean exhaust ducts.

Exhaust ducts are often used in residential, commercial, and industrial ventilation systems to provide conduits for transporting fumes, particles, or other hazardous components. Over time, buildup, such as grease, dirt, as well as other particles, form inside the exhaust ducts. This buildup obstructs passage of fumes and particles through the ducts, thereby reducing the efficiency of the ventilation systems. Moreover, the buildup is not only hazardous to human health, but is also flammable, and needs to be periodically cleaned. Although the buildup may be removed through manual cleaning, the foregoing process is often both labor intensive and time consuming due to the shapes and dimensions of the interiors of exhaust ducts. Further, given that the buildup often contains hazardous materials, additional precautions are often taken by workers, thereby not only slowing down the duct cleaning process, but also increasing the cost for such process.

### BRIEF SUMMARY OF THE DISCLOSED EMBODIMENTS

The disclosed embodiments provide systems and methods to clean ducts. In accordance with one embodiment, a method to clean an exhaust duct is provided. The method includes detecting airflow into the exhaust duct. The method also includes dosing, in response to detecting airflow into the exhaust duct, an amount of a treatment product with a fluid to produce a treatment fluid. The method further includes pumping the treatment fluid into a pipe deposited along an exhaust duct. The method further includes spraying the treatment fluid through a nozzle coupled to a section of the pipe to clean buildup formed along an area of the exhaust duct proximate to the nozzle.

In accordance with another illustrative embodiment, a cleaning system is provided. The system includes a pipe deposited along an exhaust duct. The system also includes a pump for regulating pressure of fluids flowing through the pipe. The system further includes a dosing system for dosing a treatment product with a fluid. The system further includes at least one nozzle coupled to the pipe and operable to spray a treatment fluid flowing through the pipe into the exhaust duct. The system further includes a control comprising at least one processor operable to detect airflow into the exhaust duct. The at least one processor is also operable to regulate the dosing system to dose an amount treatment product with the fluid to produce a treatment fluid. The at least one processor is further operable to regulate the pressure of the treatment fluid flowing through the pipe to clean buildup formed along the exhaust duct.

In accordance with a further illustrative embodiment, a computer-implemented method to clean a kitchen exhaust duct is provided. The method includes detecting airflow into the kitchen exhaust duct. The method also includes dosing, in response to detecting airflow into the kitchen exhaust duct, an amount of organic treatment product with water to produce a treatment fluid. The method further includes pumping the treatment fluid into a pipe deposited along the kitchen exhaust duct. The method further includes spraying the treatment fluid through a nozzle coupled to a section of the pipe at a first pulse and for a first operational duration to remove grease formed along an area of the kitchen exhaust duct proximate to the nozzle. The method further includes restricting flow of the treatment fluid through the pipe after the first operational duration. The method further includes pumping the water into the pipe. The method further includes spraying the water through the nozzle for a second operational duration commencing after the first operational duration to rinse the treatment fluid from the kitchen exhaust duct.

Additional details of the disclosed embodiments are provided below in the detailed description and corresponding drawings.

### BRIEF DESCRIPTION OF THE DRAWINGS

Illustrative embodiments of the present invention are described in detail below with reference to the attached drawing Figures, which are incorporated by reference herein, and wherein:

FIG. 1 is a schematic drawing of a duct cleaning system deployed proximate a kitchen ventilation system having one exhaust duct in accordance with one embodiment.

FIG. 2 is a schematic drawing of the duct cleaning system of FIG. 1 deployed proximate a kitchen ventilation system having multiple exhaust ducts in accordance with one embodiment.

FIG. 3 is a schematic drawing of the duct cleaning system of FIG. 1, where the duct cleaning system is communicatively connected to sensors and other measurement devices deployed along the exhaust duct, and where the duct cleaning system is able to dynamically readjust settings based on measurements obtained from such sensors and measurement devices in accordance with one embodiment.

FIG. 4 is a network environment in which the duct cleaning system of FIG. 1 is communicatively connected to one or more electronic devices deployed at remote locations in accordance with one embodiment.

FIG. 5 is a flowchart illustrating a process to clean exhaust ducts in accordance with one embodiment.

The illustrated figures are only exemplary and are not intended to assert or imply any limitation with regard to the environment, architecture, design, or process in which different embodiments may be implemented.

### DETAILED DESCRIPTION

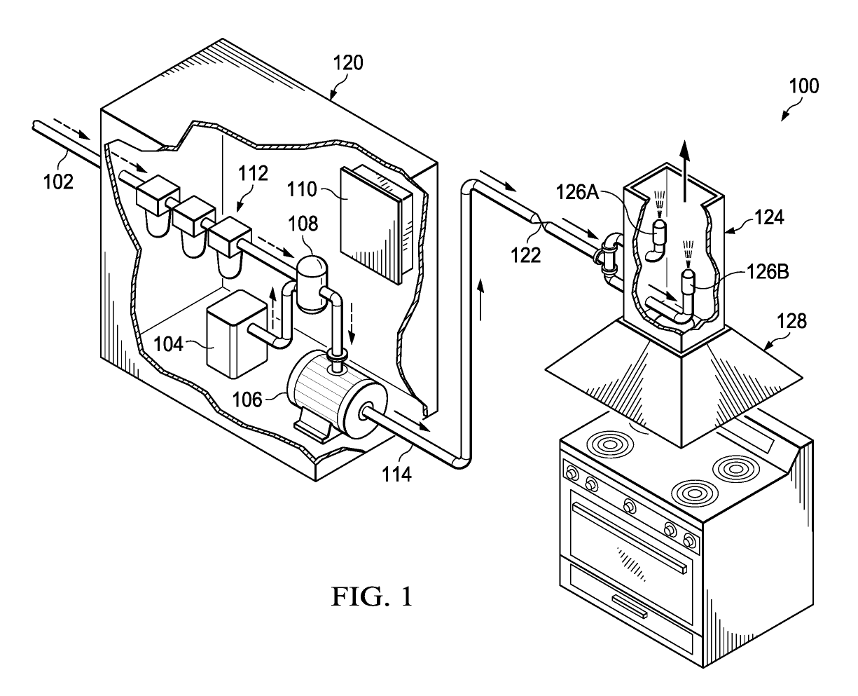

FIG. 1 is a schematic drawing of a duct cleaning system 100 deployed proximate a kitchen ventilation system 128 having one exhaust duct 124 in accordance with one embodiment. The duct cleaning system 100 includes a treatment product container 104, a pump 106, a dosing system 108, a pipe 114 that forms deployed along the exhaust duct 124, and a control 110 having one or more processors operable to control other components of the duct cleaning system 100 to perform various operations described herein to clean the exhaust duct 124. In the embodiment of FIG. 1, the treatment product container 104, the pump 106, and the control 110 are housed within a housing 120 of the duct cleaning system 100.

The duct cleaning system 100 also includes a switch 122 that regulates the operations of the duct cleaning system 100 based on whether the kitchen ventilation system 128 is in operation. In some embodiments, the switch 122 turns on the duct cleaning system 100 when the kitchen ventilation system 128 is in operation and turns off the duct cleaning system 100 when the kitchen ventilation system 128 is not in operation. In some embodiments, the switch 122 is a pressure switch that is operable to determine whether a sufficient amount of air is flowing through an exhaust fan (not shown) of the kitchen ventilation system 128. In one of such embodiments, the switch 122 is a differential pressure switch that is operable to monitor an amount of airflow into the exhaust duct 124.

The duct cleaning system 100 is connected to an inlet pipe 102 that provides fluids, such as water from a fluid source such as a nearby water pipe or a faucet, to the duct cleaning system 100. In some embodiments, the inlet pipe 102 is coupled to filters 112, which filter out undesired materials and minerals from the fluids before the fluids are used to clean the exhaust duct 124. Examples of such filters 112 include carbon filters, sediment filters, calcium filters, as well as other types of mineral filters. The duct cleaning system 100 also includes a treatment container 104, which holds treatment products used to clean buildup, such as grease, dirt, as well as other particles formed in the exhaust ducts over time (collectively “buildup”). In some embodiments, the treatment products are formed from consumable products. Examples of such consumable products include certain types of vegetative, non-spore forming bacteria, enzymes, odor control agents, natural surfactants, as well as other types of biological or organic products that are operable to breakdown buildup. In the primary embodiment, the treatment products are selected from naturally occurring, non-hazardous, non-toxic, non-pathogenic, non-corrosive, and non-caustic products that are environmentally friendly, thereby alleviating hazard from direct and indirect exposure to such treatment products.

The inlet pipe 102 and the treatment product container 104 are both connected to the dosing system 108 component of the duct cleaning system 100. The dosing system 108 is operable to mix the treatment product with the fluid to form a treatment fluid that is used to breakdown buildup described herein. In some embodiments, the control 110 is operable to regulate the dosing system 108 to control the ratio of treatment product mixed with the fluid. In one of such embodiments, the control 110 is operable to regulate the dosing system 108 to control the ratios of treatment product to the fluid to within 0.1% accuracy to produce a treatment fluid that contains anywhere from 0.1% to 99.9% treatment product. In some embodiments, the ratio of treatment product to fluid, and treatment product to treatment fluid are predetermined based on the type of use as well as the type of buildup that forms within the exhaust duct 124. In other embodiments, the foregoing ratio may be dynamically adjusted. Additional descriptions of such embodiments are provided in the paragraphs below.

In the embodiment of FIG. 1, the treatment fluid produced by the dosing system 108 flows through a conduit to the pump 106. In some embodiments, the control 110 operates the pump 106 to pressurize the treatment fluid to flow through the pipe 114. In one of such embodiments, the control 110 operates a variable frequency drive of the pump 106 to pressurize the treatment fluid between approximately 15 Bar and 100 Bar. First and second nozzles 126A and 126B are fitted to two ends of the pipe 114 to control a direction and characteristics of the flow of the treatment fluid as such fluid exits the nozzle. In one of such embodiments, the treatment fluid flows out of the first and second nozzles 126A and 126B in a mist. In another one of such embodiments, the treatment fluid flows out of the first and second nozzles 126A and 126B in a constant stream. In a further one of such embodiments, the treatment fluid flow out of the first and second nozzles 126A and 126B on a pulse cycle. For example, the control 110 is operable to control the release of the treatment fluid from the first and second nozzles 126A and 126B at a predetermined frequency. Moreover, the control 110 is also operable to vary the frequency of the release of the treatment fluid, thereby adjusting the pulse cycle of the release of the treatment fluid into the exhaust duct 124.

In some embodiments, the duct cleaning system 100 releases the treatment fluid into the exhaust duct 124 for a predetermined operational duration (the duration of which, the treatment fluid is released into the exhaust duct is referred to as “treatment cycle”). In further embodiments, the duct cleaning system 100 releases the treatment fluid into the exhaust duct 124 for a variable operational duration based on the amount of buildup in the exhaust duct 124, based on the type of kitchen operation, based on a change in the speed of the exhaust fan, and/or based on other factors described herein. In some embodiments, the duct cleaning system 100, after releasing the treatment fluid into the exhaust duct 124 for the predetermined or variable duration, commences an operation to rinse the treatment fluid from the exhaust duct 124. In one of such embodiments, the duct cleaning system 100 restricts the flow of the treatment fluid into the pipe 114 and pumps a rinsing fluid such as water through the pipe 114, and out of the first and second nozzles 126A and 126B to rinse the treatment fluid, as well as the buildup, from the exhaust duct 124. In one of such embodiments, the operational duration of the rinse cycle is predetermined. In another one of such embodiments, the operational duration of the rinse cycle dynamically varies based on the amount of buildup in the exhaust duct 124, based on the type of kitchen operation, based on a change in the speed of the exhaust fan, and/or based on other factors described herein. In some embodiments, the duct cleaning system 100 initiates another treatment cycle after completion of the rinse cycle. In other embodiments, the duct cleaning system 100 shuts down for a period of time after completing the treatment cycle and the rinse cycle. Although FIG. 1 illustrates the duct cleaning system 100 deployed in an exhaust duct of a kitchen ventilation system, the duct cleaning system 100 may also be utilized to perform the operations described herein to remove buildup from other types of ducts or annuluses. Further, although FIG. 1 illustrates the duct cleaning system 100 having two nozzles 126A and 126B, the duct cleaning system 100 may deploy a different number of nozzles to perform operations described herein.

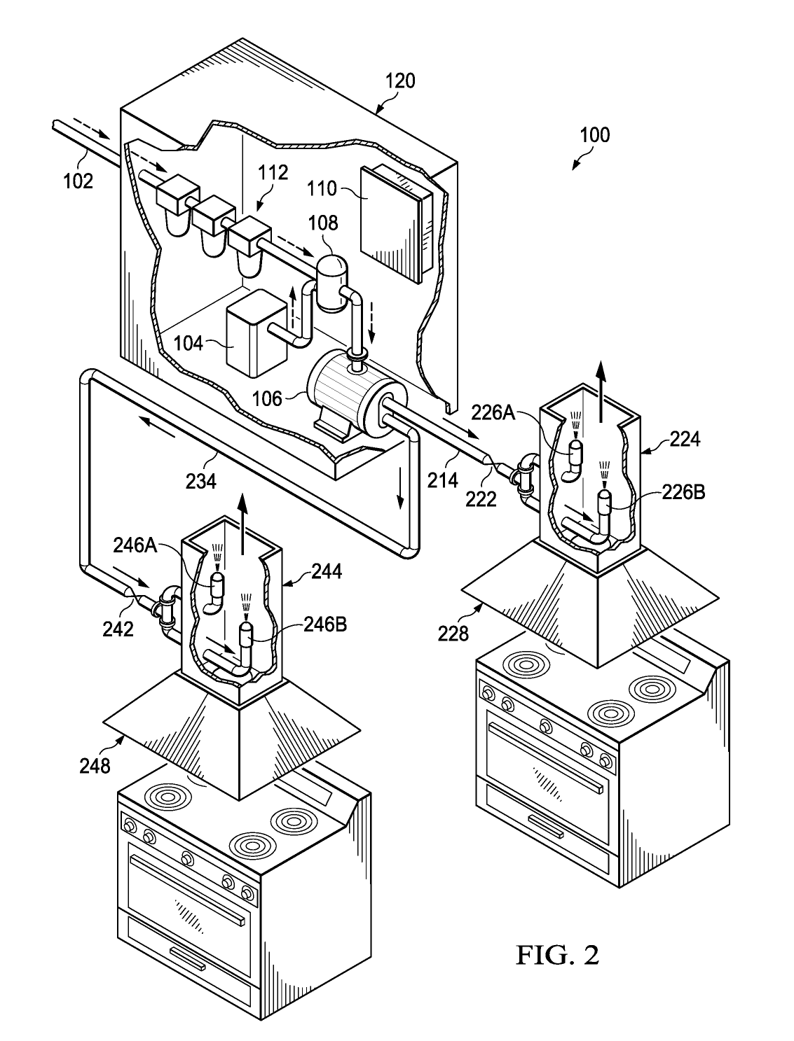

FIG. 2 is a schematic drawing of the duct cleaning system 100 of FIG. 1 deployed proximate a kitchen ventilation system 228 having first and second exhaust ducts 226A and 226B in accordance with one embodiment. The duct cleaning system 100 includes a first pipe 214 that is deployed along a first exhaust duct 224 and a second pipe 234 that is deployed along a second exhaust duct 244. Moreover, the first pipe 214 is fitted with first and second nozzles 226A and 226B and the second pipe 234 is fitted with third and fourth nozzles 246A and 246B. As such, the duct cleaning system 100 is operable to simultaneously transmit the treatment fluid to clean both the first and the second exhaust ducts 224 and 244. As shown in FIG. 2, first and second switches 222 and 242 are deployed along the first and second exhaust ducts 224 and 244, and are operable to regulate the operations of the duct cleaning system 100 on the first and second exhaust ducts 224 and 244, respectively. In some embodiments, the first switch 222 allows the duct cleaning system 100 to initiate treatment cycles and rinse cycles in the first exhaust duct 224 if an exhaust fan of the first exhaust duct 224 is on. Similarly, the second switch 224 allows the duct cleaning system 100 to initiate treatment cycles and rinse cycles in the second exhaust duct 224 if an exhaust fan of the second exhaust duct 244 is on. In some embodiments, the control 110 turns on the duct cleaning system 100 when kitchen ventilation system 228 is in operation and turns off the duct cleaning system 100 when the kitchen ventilation system 228 is not in operation.

In some embodiments, the first and second switches 222 and 242 are pressure switches that are operable to determine whether a sufficient amount of air is flowing through an exhaust fan (not shown) of the kitchen ventilation system 228. In one of such embodiments, the first switch 222 is a differential pressure switch that is operable to monitor an amount of airflow into the first exhaust duct 224 and the second switch 242 is a differential pressure switch that is operable to monitor an amount of airflow into the second exhaust duct 244. In some embodiments, the control 110 regulates the pump 106 to adjust the pressure at which the treatment fluid is pumped into the first and the second pipes 214 and 234, respectively. In one of such embodiments, the control 110 regulates the pump 106 to provide treatment fluids having approximately equal pressure into the first and the second pipes 214 and 234. In another one of such embodiments, the control 110 regulates the pump 106 to provide treatment fluids having different pressures into the first and second pipes 214 and 234. In further embodiments, the control 110 dynamically adjusts the pressure at which the treatment fluid is pumped into the first and the second pipes 214 and 234. In one of such embodiments, the control 110 dynamically adjusts the pressure at which the treatment fluid is pumped into the first and the second pipes 214 and 234 based on the amount of buildup in the first and second exhaust ducts 224 and 244, respectively, based on the type of kitchen operation, based on a change in the speed of the exhaust fans of the first and the second exhaust ducts 224 and 244, respectively, and/or based on other factors described herein.

In some embodiments, the treatment fluid is released from the first-fourth nozzles 226A, 226B, 246A, and 246B on an approximately identical pulse cycle. In further embodiments, the pulse cycle, at which the treatment fluid is released from the first and second nozzles 226A and 226B is different from the pulse cycle, at which the treatment fluid is released from the third and fourth nozzles 246A and 246B. In further embodiments, the control 110 is operable to vary the frequency of the release of the treatment fluid into the first and the second pipes 214 and 234, thereby adjusting the pulse cycle of the release of the treatment fluid into the first and second exhaust ducts 224 and 244, respectively. Although the duct cleaning system 100 depicted in FIG. 2 is connected to two exhaust ducts 224 and 244, one of ordinary skill would understand that a similar duct cleaning system 100 may be utilized to a ventilation system having three or more exhaust ducts.

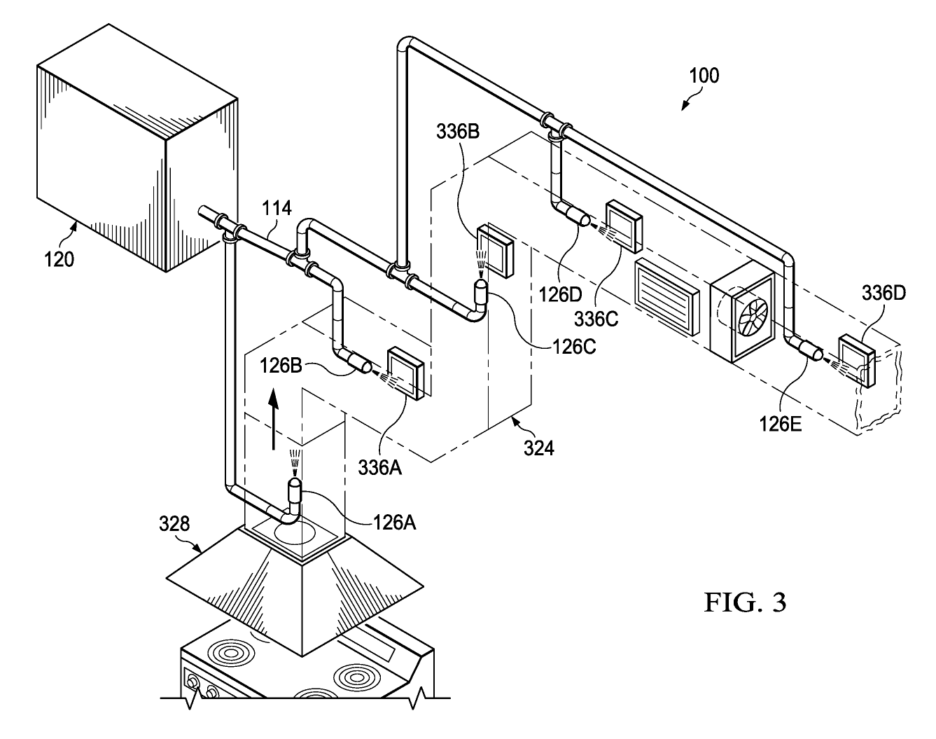

FIG. 3 is a schematic drawing of the duct cleaning system 100 of FIG. 1, where the duct cleaning system 100 is communicatively connected to sensors 336A-336D and other measurement devices deployed along the exhaust duct 324, and where the duct cleaning system 100 is able to dynamically readjust settings based on measurements obtained from such sensors and measurement devices in accordance with one embodiment. As shown in FIG. 3, first, second, third, and fourth sensors 336A-336D are deployed along exhaust duct 324 of kitchen ventilation system 328. In some embodiments, the first-fourth sensors 336A-336D are operable to measure an amount of buildup proximate the sensors and are operable to provide signals indicative of such measurements to the control 110. In some embodiments, the control 110, upon detecting signals indicative of the existence of buildup or a change in the buildup proximate to one or more of the first-fourth sensors 336A-336D, is dynamically operable to initiate a treatment cycle, to extend the operational duration of the treatment cycle, and/or schedule future treatment cycles. In further embodiments, the control 110 is operable to dynamically readjust the pressure, at which the treatment fluid is pumped into the exhaust duct 324 upon detecting signals indicative of the existence of buildup or a change in the buildup proximate to one or more of the first-fourth sensors 336A-336D.

In further embodiments, the control 110 is operable to dynamically readjust the pulse cycle of the release of the treatment fluid into the exhaust duct 324 in response to detecting signals indicative of an existence of buildup or a change in the buildup proximate to one or more of the first-fourth sensors 336A-336D. In further embodiments, the control 110 is operable to dynamically readjust the treatment product to fluid ratio in response to detecting signals indicative of the existence of buildup or a change in the buildup proximate to one or more of the first-fourth sensors 336A-336D. In further embodiments, the first-fourth sensors 336A-336D are operable to measure an amount of treatment fluid flowing through the exhaust duct 324. The control 110, upon detecting signals indicative of the amount of treatment fluid in the exhaust duct 324, is dynamically operable to end a current treatment cycle and to initiate a new rinse cycle.

In some embodiments, the control 110 is communicatively connected and interfaced with third party management systems that detect a level of activity (such as kitchen activity). The control 110 is further operable to regulate one or more of the duration and frequency of treatment cycles, the duration and frequency of rinse cycles, the pulse cycle frequency, the pressure at which the treatment fluid is injected into the pipe 114, as well as make other dynamic adjustments described herein based on signals indicative of the kitchen activity. As such, the duct cleaning system 100 is operable to continuously and dynamically modify its operations based on current conditions to improve its efficiency and to reduce costs associated with running such system.

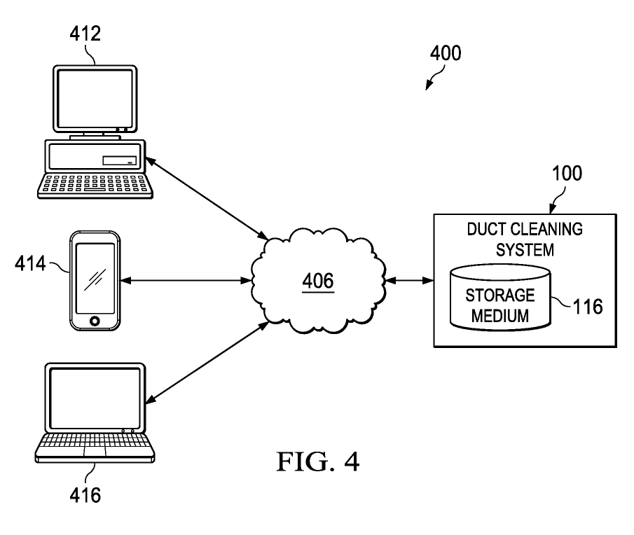

FIG. 4 is a network environment 400, in which the duct cleaning system 100 of FIG. 1 is communicatively connected to one or more electronic devices 412, 414, and 416 deployed at remote locations in accordance with one embodiment.

The duct cleaning system 100 includes or is communicatively connected to storage medium 116. The storage medium 116 is formed from data storage components such as, but not limited to, read-only memory (“ROM”), random access memory (“RAM”), flash memory, magnetic hard drives, solid state hard drives, CD-ROM drives, DVD drives, floppy disk drives, as well as other types of data storage components and devices. In some embodiments, the storage medium 116 includes multiple data storage devices. In further embodiments, the multiple data storage devices may be physically stored at different locations. In some embodiments, the storage medium 116 stores data indicative of performance logs, status reports, schedules, diagnostics, as well as other data related to the history, performance, or status of the duct cleaning system 100. In some embodiments, the storage medium 116 also contains instructions which, when performed by one or more processors of the control 110, causes the one or more processors to detect where there is airflow into the exhaust duct 124, dose, in response to detecting airflow into the exhaust duct 124, the treatment product with the fluid to produce the treatment fluid, pump the treatment fluid into the pipe 114, spray the treatment fluid through the first and second nozzles 126A and 126B to clean buildup in the exhaust duct 124, and to perform other operations described herein.

The electronic devices 412, 414, and 416 may be electronic devices of the owner of the duct cleaning system 100, product suppliers of the duct cleaning system 100, technicians of the duct cleaning system 100, as well as other authorized personnel (“users”). The duct cleaning system 100 is operable to provide the users with up-to-date status reports of its operations, diagnostics, as well as supply levels via the network 406. For example, the duct cleaning system 100 may provide the user with a schedule of upcoming operations, provide the supplier with a notice that additional treatment products should be added to the treatment product container 104, as well as other messages and notifications. Further, the users may utilize their electronic devices 412, 414, and 416 to communicate with the duct cleaning system 100 and to dynamically adjust one or more operations of the duct cleaning system 100 as described herein.

The network 406 can include, for example, any one or more of a cellular network, a satellite network, a personal area network (PAN), a local area network (LAN), a wide area network (WAN), a broadband network (BBN), the Internet, and the like. Further, the network 406 can include, but is not limited to, any one or more of the following network topologies, including a bus network, a star network, a ring network, a mesh network, a star-bus network, tree or hierarchical network, or similar network architecture. In some embodiments, the network 406 includes a wired or wireless networking device (not shown) operable to facilitate communication between the duct cleaning system 100 and the electronic devices 412, 414, and 416. Examples of the networking device include, but are not limited to, wired and wireless routers, wired and wireless modems, access points, as well as other types of suitable networking devices described herein.

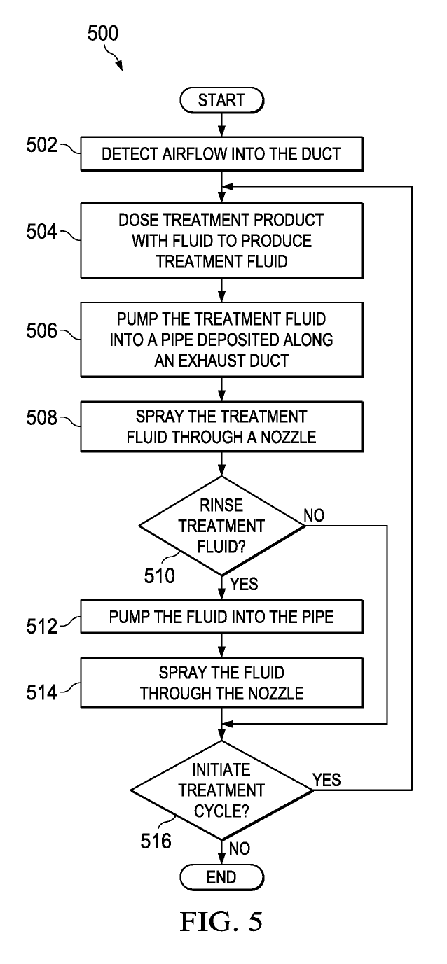

FIG. 5 is a flowchart illustrating a process 500 to clean exhaust ducts in accordance with one embodiment. Although operations in the process 500 are shown in a particular sequence, certain operations may be performed in different sequences or at the same time where feasible. Further, although the following paragraphs describe performing the process 500 to clean an exhaust duct, the process 500 may also be performed to clean other types of ducts and annuluses.

At step 502, airflow into the exhaust duct 124 is detected. In some embodiments, a differential pressure system detects a change in pressure generated by airflow into the exhaust. In one of such embodiments, the differential pressure system determines that air is flowing into the exhaust if the change in pressure is above a threshold value. In one of such embodiments, the control 110 is operable to turn on the duct cleaning system 100 if the pressure is above the threshold value, thereby ensuring that the duct cleaning system 100 is only turned on when the exhaust system is in operation. In another one of such embodiments, the control 110 is operable to immediately shut off the duct cleaning system 100 or shut off the duct cleaning system 100 after an operational duration if the pressure falls below the threshold value. At step 504, the dosing system 108 doses the treatment product with a fluid such as water to produce treatment fluid. In some embodiments, the control 110 is operable to control the dosing system 108 to dose a predetermined amount of treatment product with the fluid to produce the treatment fluid. In one of such embodiments, the control 110 is operable to regulate the dosing system 108 to control the ratio of treatment product to the fluid to within 0.1% accuracy to produce the treatment fluid that contains anywhere from 0.1% to 99.9% of the treatment product. In further embodiments, the control 110 is operable to adjust the ratio of treatment product to fluid based on predetermined instructions. For example, the control 110 is operable to operate the dosing system 108 to dose different amounts of treatment product into the fluid based on the amount of grease detected in the exhaust, how long the duct cleaning system 100 has been running, as well as other factors described herein.

At step 506, the pump 106 pumps the treatment fluid into the pipe 114, which is fitted with first and second nozzles 126A and 126B. At step 508, the treatment fluid is sprayed through the first and second nozzles 126A and 126B into the exhaust duct 124 for a first operational duration to clean buildup formed on the exhaust duct 124. In some embodiments, the control 110 is operable to regulate the pulse cycle of the release of the treatment fluid into the exhaust duct 124. In one of such embodiments, the control 110 sets the pulse cycle to a pre-programmed pulse cycle. In further embodiments, the control 110 dynamically readjusts the pulse cycle based on the amount of grease in the exhaust 124.

At step 510, the control 110 determines whether to initiate the rinse cycle. In some embodiments, the control 110 determines to initiate the rinse cycle after a predetermined period of operation. For example, the control 110 may initiate the rinse cycle after the treatment fluid has been continuously pumped into the pipe 114 for 15 minutes, 30 minutes, 1 hour, or another operational duration. In some embodiments, the control 110 determines to initiate the rinse cycle after a predetermined amount of treatment fluid has been pumped into the pipe 114. In further embodiments, the control 110 is operable to receive an indication of the amount of grease remaining in the exhaust duct 124 and is operable to dynamically initiate the rinse cycle based on the amount of grease in the exhaust duct 124. If control 110 determines that the rinse cycle should begin, then the process proceeds to 512, and a rinsing fluid such as water is pumped into the pipe 114. In some embodiments, the rinsing fluid is water. In other embodiments, the rinsing fluid is another type of cleaning fluid that is pumped through the pipe 124, out of the first and second nozzles 126A and 126B, and into the exhaust duct 124. At step 514, the rinsing fluid is sprayed through the first and second nozzles for a second operational duration. In some embodiments, the length of the second operational duration is preselected. In further embodiments, the control 110 is operable to adjust the length of the second operational duration based on at least one of the amount of grease in the duct and the amount of treatment fluids in the duct.

The process proceeds to step 516 after rinsing cycle and the control 110 determines whether to initiate a new treatment cycle. Similarly, at step 510, process proceeds to 516 if the control 110 determines not to initiate the rinse cycle. If the control 110 determines at step 516 not to initiate a new treatment cycle, then the process ends. Alternatively, if the process at step 516 determines to initiate the new treatment cycle, then the process returns to step 504. In some embodiments, the control 110 is operable to dynamically communicate with different users via a network, such as the network 406 to update the users with the status of the duct cleaning system 100. In further embodiments, the control 110 is further operable to receive instructions from the users and to dynamically adjust one or more operations described herein based on such instructions.

As used in this specification and any claims of this application, the terms “computer”, “server”, “processor”, and “memory” all refer to electronic or other technological devices. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

The above disclosed embodiments have been presented for purposes of illustration and to enable one of ordinary skill in the art to practice the disclosed embodiments, but is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/blocks may be performed in parallel or out of sequence, or combined into a single step/block. The scope of the claims is intended to broadly cover the disclosed embodiments and any such modification. Further, the following clauses represent additional embodiments of the disclosure and should be considered within the scope of the disclosure:

Clause 1, a method to clean an exhaust duct, the method comprising detecting airflow into the exhaust duct; dosing, in response to detecting airflow into the exhaust duct, an amount of a treatment product with a fluid to produce a treatment fluid; pumping the treatment fluid into a pipe deposited along the exhaust duct; and spraying the treatment fluid through a nozzle coupled to a section of the pipe to clean buildup formed along an area of the exhaust duct proximate to the nozzle.

Clause 2, the method of clause 1, further comprising detecting airflow into a second exhaust duct; pumping the treatment fluid into the second exhaust duct in response to detecting airflow into the second exhaust duct; regulating pressure at which the treatment fluid is pumped into the pipe and into a second pipe deposited along the second exhaust duct; and spraying the treatment fluid through a second nozzle coupled to a section of the second pipe to clean buildup formed along an area of the second exhaust duct proximate to the second nozzle.

Clause 3, the method of clause 1 or 2, further comprising detecting a first amount of buildup formed along the area of the exhaust duct; detecting a second amount of buildup formed along the area of the second exhaust duct; and dynamically adjusting the pressure at which the treatment fluid is pumped into the pipe and into the second pipe to balance the pressure at which the treatment fluid is pumped into the pipe and into the second pipe.

Clause 4, the method of any of clauses 1-3, further comprising simultaneously regulating a first pulse, at which the treatment fluid is sprayed through the nozzle of the pipe and a second pulse, at which the treatment fluid is sprayed through the second nozzle of the second pipe; and simultaneously regulating a first operational duration, during which, the treatment fluid is sprayed through the nozzle of the pipe and a second operational duration, during which the treatment fluid is sprayed through the second nozzle of the second pipe.

Clause 5, the method of any of clauses 1-4, further comprising: detecting a first amount of buildup formed along the area of the exhaust duct; detecting a second amount of buildup formed along the area of the second exhaust duct; and dynamically adjusting pressure at which the treatment fluid is pumped into the pipe and into the second pipe based on the amount of buildup formed along the area of the exhaust duct and formed along the area of the second exhaust duct.

Clause 6, the method of any of clauses 1-5, further comprising spraying the treatment fluid through a second nozzle coupled to a second section of the pipe to clean buildup formed along a second area of the exhaust duct proximate to the second nozzle.

Clause 7, the method of any of clauses 1-6, further comprising detecting a fan speed of a fan positioned proximate the exhaust duct, wherein detecting the airflow into the exhaust duct comprises detecting whether the fan speed of the fan is above a threshold.

Clause 8, the method of any of clauses 1-7, further comprising detecting a variation in the fan speed of the fan; and dynamically varying a pressure at which the treatment fluid is pumped into the pipe based on the variation of the speed of the fan.

Clause 9, the method of any of clauses 1-8, further comprising detecting a change in an amount of buildup along a section of the exhaust duct; and dynamically varying a pressure at which the treatment fluid is pumped into the pipe based on the change in the amount of buildup along the section of the exhaust duct.

Clause 10, the method of any of clauses 1-9, further comprising detecting a change in an amount of buildup along a section of the exhaust duct; and dynamically varying an amount of time, during which the treatment fluid is sprayed through the nozzle based on the change in the buildup along the section of the exhaust duct.

Clause 11, the method of any of clauses 1-10, further comprising detecting a change in an amount of buildup along a section of the exhaust duct; and dynamically varying frequency of a pulse, at which the treatment fluid is sprayed through the nozzle based on the change in the buildup along the section of the exhaust duct.

Clause 12, the method of any of clauses 1-11, further comprising detecting a change in an amount of buildup along a section of the exhaust duct; and dynamically varying a ratio, based on which, the treatment product and the fluid are mixed to produce the treatment fluid based on the change in the buildup along the section of the exhaust duct.

Clause 13, the method of any of clauses 1-12, wherein the treatment is a bacteria organism, wherein the fluid is water, and wherein dosing the amount of the treatment product with the fluid comprises dosing a predetermined ratio to bacteria in water to produce the treatment fluid.

Clause 14, the method of any of clauses 1-13, further comprising restricting flow of the treatment fluid through the pipe; pumping a rinsing fluid into the pipe; and spraying a rinsing fluid through the nozzle to rinse the treatment fluid from the exhaust duct.

Clause 15, the method of any of clauses 1-14, wherein spraying the treatment fluid comprises spraying the treatment fluid into the exhaust duct at a designated pulse.

Clause 16, a duct cleaning system comprising a pipe deposited along an exhaust duct; a pump for regulating pressure of fluids flowing through the pipe; a dosing system for dosing a treatment product with a fluid; at least one nozzle coupled to the pipe and operable to spray a treatment fluid flowing through the pipe into the exhaust duct; and a control comprising at least one processor operable to regulate the dosing system to dose an amount treatment product with the fluid to produce a treatment fluid; and regulate pressure of the treatment fluid flowing through the pipe to clean buildup formed along the exhaust duct.

Clause 17, the duct cleaning system of clause 16, wherein the at least one processor is further operable to detect a fan speed of a fan positioned proximate the exhaust duct; and regulate the dosing system based on the fan speed of the fan.

Clause 18, the duct cleaning system of clause 16 or 17, wherein the at least one processor is further operable to detect a variation in the fan speed of the fan; and dynamically vary the pressure of the treatment fluid flowing through the pipe based on the variation of the fan speed of the fan.

Clause 19, the duct cleaning system of any of clauses 16-18, wherein the at least one processor is further operable to detect a change in an amount of buildup along a section of the exhaust duct; and dynamically vary, based on the change in the buildup along the section of the exhaust duct, at least one of the pressure of the treatment fluid flowing through the pipe, an amount of time, during which the treatment fluid is sprayed through the nozzle, frequency of a pulse, at which the treatment fluid is sprayed through the nozzle, and a ratio, based on which, the treatment product and the fluid are mixed to produce the treatment fluid.

Clause 20, a computer-implemented method to clean a kitchen exhaust duct, the method comprising detecting airflow into the kitchen exhaust duct; dosing, in response to detecting airflow into the kitchen exhaust duct, an amount of organic treatment product with water to produce a treatment fluid; pumping the treatment fluid into a pipe deposited along the kitchen exhaust duct; spraying the treatment fluid through a nozzle coupled to a section of the pipe at a first pulse and for a first operational duration to remove grease formed along an area of the kitchen exhaust duct proximate to the nozzle; restricting flow of the treatment fluid through the pipe after the first operational duration; pumping the water into the pipe; and spraying the water through the nozzle for a second operational duration commencing after the first operational duration to rinse the treatment fluid from the kitchen exhaust duct.

As used herein, the singular forms “a”, “an” and “the” are intended to include the plural forms as well, unless the context clearly indicates otherwise. Unless otherwise indicated, as used throughout this document, “or” does not require mutual exclusivity. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

It should be apparent from the foregoing that embodiments of an invention having significant advantages have been provided. While the embodiments are shown in only a few forms, the embodiments are not limited but are susceptible to various changes and modifications without departing from the spirit thereof.

We claim:

1. A method to clean an exhaust duct, the method comprising:
detecting airflow into the exhaust duct;
dosing, in response to detecting airflow into the exhaust duct, an amount of a treatment product with a fluid to produce a treatment fluid;
pumping the treatment fluid into a pipe deposited along the exhaust duct; and
spraying the treatment fluid through a nozzle coupled to a section of the pipe to clean buildup formed along an area of the exhaust duct proximate to the nozzle.

2. The method of claim 1, further comprising:
detecting airflow into a second exhaust duct;
pumping the treatment fluid into the second exhaust duct in response to detecting airflow into the second exhaust duct;
regulating pressure at which the treatment fluid is pumped into the pipe and into a second pipe deposited along the second exhaust duct; and
spraying the treatment fluid through a second nozzle coupled to a section of the second pipe to clean buildup formed along an area of the second exhaust duct proximate to the second nozzle.

3. The method of claim 2, further comprising:
detecting a first amount of buildup formed along the area of the exhaust duct;
detecting a second amount of buildup formed along the area of the second exhaust duct; and
dynamically adjusting the pressure at which the treatment fluid is pumped into the pipe and into the second pipe to balance the pressure at which the treatment fluid is pumped into the pipe and into the second pipe.

4. The method of claim 2, further comprising:
simultaneously regulating a first pulse, at which the treatment fluid is sprayed through the nozzle of the pipe and a second pulse, at which the treatment fluid is sprayed through the second nozzle of the second pipe; and
simultaneously regulating a first operational duration, during which, the treatment fluid is sprayed through the nozzle of the pipe and a second operational duration, during which the treatment fluid is sprayed through the second nozzle of the second pipe.

5. The method of claim 2, further comprising:
detecting a first amount of buildup formed along the area of the exhaust duct;
detecting a second amount of buildup formed along the area of the second exhaust duct; and
dynamically adjusting pressure at which the treatment fluid is pumped into the pipe and into the second pipe based on the amount of buildup formed along the area of the exhaust duct and formed along the area of the second exhaust duct.

6. The method of claim 1, further comprising spraying the treatment fluid through a second nozzle coupled to a second section of the pipe to clean buildup formed along a second area of the exhaust duct proximate to the second nozzle.

7. The method of claim 1, further comprising detecting a fan speed of a fan positioned proximate the exhaust duct, wherein detecting the airflow into the exhaust duct comprises detecting whether the fan speed of the fan is above a threshold.

8. The method of claim 7, further comprising:
detecting a variation in the fan speed of the fan; and
dynamically varying a pressure at which the treatment fluid is pumped into the pipe based on the variation of the speed of the fan.

9. The method of claim 1, further comprising:
detecting a change in an amount of buildup along a section of the exhaust duct; and
dynamically varying a pressure at which the treatment fluid is pumped into the pipe based on the change in the amount of buildup along the section of the exhaust duct.

10. The method of claim 1, further comprising:
detecting a change in an amount of buildup along a section of the exhaust duct; and
dynamically varying an amount of time, during which the treatment fluid is sprayed through the nozzle based on the change in the buildup along the section of the exhaust duct.

11. The method of claim 1, further comprising:
detecting a change in an amount of buildup along a section of the exhaust duct; and
dynamically varying frequency of a pulse, at which the treatment fluid is sprayed through the nozzle based on the change in the buildup along the section of the exhaust duct.

12. The method of claim 1, further comprising:
detecting a change in an amount of buildup along a section of the exhaust duct; and
dynamically varying a ratio, based on which, the treatment product and the fluid are mixed to produce the treatment fluid based on the change in the buildup along the section of the exhaust duct.

13. The method of claim 1, wherein the treatment is a bacteria organism, wherein the fluid is water, and wherein dosing the amount of the treatment product with the fluid comprises dosing a predetermined ratio to bacteria in water to produce the treatment fluid.

14. The method of claim 1, further comprising:
restricting flow of the treatment fluid through the pipe;
pumping a rinsing fluid into the pipe; and
spraying a rinsing fluid through the nozzle to rinse the treatment fluid from the exhaust duct.

15. The method of claim 1, wherein spraying the treatment fluid comprises spraying the treatment fluid into the exhaust duct at a designated pulse.

16. A duct cleaning system comprising:
a pipe deposited along an exhaust duct;
a pump for regulating pressure of fluids flowing through the pipe;
a dosing system for dosing a treatment product with a fluid;
at least one nozzle coupled to the pipe and operable to spray a treatment fluid flowing through the pipe into the exhaust duct; and
a control comprising at least one processor operable to:
regulate the dosing system to dose an amount treatment product with the fluid to produce a treatment fluid; and
regulate pressure of the treatment fluid flowing through the pipe to clean buildup formed along the exhaust duct.

17. The duct cleaning system of claim 16, wherein the at least one processor is further operable to:
detect a fan speed of a fan positioned proximate the exhaust duct; and
regulate the dosing system based on the fan speed of the fan.

18. The duct cleaning system of claim 17, wherein the at least one processor is further operable to:
detect a variation in the fan speed of the fan; and
dynamically vary the pressure of the treatment fluid flowing through the pipe based on the variation of the fan speed of the fan.

19. The duct cleaning system of claim 16, wherein the at least one processor is further operable to:
detect a change in an amount of buildup along a section of the exhaust duct; and
dynamically vary, based on the change in the buildup along the section of the exhaust duct, at least one of the pressure of the treatment fluid flowing through the pipe, an amount of time, during which the treatment fluid is sprayed through the nozzle, frequency of a pulse, at which the treatment fluid is sprayed through the nozzle, and a ratio, based on which, the treatment product and the fluid are mixed to produce the treatment fluid.

20. A computer-implemented method to clean a kitchen exhaust duct, the method comprising:
detecting airflow into the kitchen exhaust duct;
dosing, in response to detecting airflow into the kitchen exhaust duct, an amount of organic treatment product with water to produce a treatment fluid;
pumping the treatment fluid into a pipe deposited along the kitchen exhaust duct;
spraying the treatment fluid through a nozzle coupled to a section of the pipe at a first pulse and for a first operational duration to remove grease formed along an area of the kitchen exhaust duct proximate to the nozzle;
restricting flow of the treatment fluid through the pipe after the first operational duration;
pumping the water into the pipe; and
spraying the water through the nozzle for a second operational duration commencing after the first operational duration to rinse the treatment fluid from the kitchen exhaust duct.
